(19) United States
(12) Patent Application Publication
(10) Pub. No.: US 2023/0294958 A1
(43) Pub. Date: Sep. 21, 2023

(54) ELEVATOR AND METHOD FOR CONTROLLING ELEVATOR

(71) Applicants: Yuqi Han, Shenzhen, Guangdong (CN); Peiwen Han, Shenzhen, Guangdong (CN)

(72) Inventors: Yuqi Han, Shenzhen, Guangdong (CN); Peiwen Han, Shenzhen, Guangdong (CN)

(21) Appl. No.: 18/011,535

(22) PCT Filed: Jul. 31, 2020
(86) PCT No.: PCT/CN2020/106312

§ 371 Date: Dec. 20, 2022

(51) Int. Cl. B66B 1/28; B66B 7/10

(52) U.S. Cl. CPC B66B 1/28; B66B 7/10

(57) ABSTRACT

An elevator and an elevator control method are provided. The elevator includes a car (4) and counterweights (10); the elevator includes posts (2), a steel frame structure (13), and a power device (7), where the steel frame structure (13) is fixed on the top of the elevator, and the power device (7) is fixedly installed on the steel frame structure (13); and the counterweights (10) are disposed in the posts (2).

### TECHNICAL FIELD

The present invention relates to the field of elevator technologies, and specifically to an elevator with an open hatchway structure and a method for controlling an elevator.

### BACKGROUND

Elevators may be divided into several forms such as a steel wire rope driving elevator, a hydraulic driving elevator, a pinion and rack driving elevator, and a sprocket and chain driving elevator according to driving manners.

The steel wire rope driving elevator is a vertical lift powered by a motor, a main function of a traction system is to output and transfer power, to run the elevator, and a traction steel wire rope is connected to a car, and is used for carrying people or carrying cargo in a multi-story building. To ensure that a friction force between the steel wire rope and a rope groove of a traction wheel is sufficient to drive the car to ascend or descend, the exterior of the traction wheel needs to be usually wrapped with a layer of material with a huge friction force. However, because the traction wheel is in a load-bearing state for a long term, requirements for the traction wheel are relatively high, and costs are relatively high. A fixed counterweight is used for a conventional elevator to balance the weight of a load, and plays a role in quantitative balancing, but can balance only a part of the weight of the load. When the elevator is fully loaded or lightly loaded, a driving force is relatively large, and energy consumption is relatively large. Moreover, the principle of friction transmission between a steel wire rope and a traction wheel is used for a car, that is, a friction force between the traction wheel and the steel wire rope drives the car. If wearing occurs between the steel wire rope and the traction wheel, the friction coefficient is reduced, the friction force is reduced, the traction steel wire rope slips, and it is easy for the car to have an accident of plunging to the bottom or shooting up to the top. As a result, safety and reliability are poor.

The patent document with the patent No. 201821043559 discloses a load self-balancing elevator, including a car ascending or descending in an elevator shaft, a traction machine installed on the top of a hatchway of the elevator shaft, a traction steel wire rope, a counterweight, and an electric control system. Two ends of the traction steel wire rope are connected to the car and the counterweight respectively, the traction steel wire rope is placed in a rope groove of a traction wheel of the traction machine, and the electric control system controls the traction machine to rotate, thereby driving the traction steel wire rope to pull the car to ascend or descend. The elevator further includes a counterbalancing system used for self-balancing a load of the elevator. The counterbalancing system includes a cross chain, a cross chain driving mechanism, and a weight controller. The weight controller is electrically connected to the cross chain driving mechanism, the cross chain is connected to the cross chain driving mechanism in a meshing manner, and the traction steel wire rope is connected to the car and then connected to the weight controller. When the load of the elevator is not balanced, the weight controller controls, by pulling the car through the traction steel wire rope, the cross chain driving mechanism to rotate, thereby driving the cross chain to move, until the load of the elevator is balanced.

The inventor finds that, in the technical solution of the foregoing disclosed elevator, the traction wheel plus a plurality of steel wire ropes is used for transmission, the steel wire ropes are pulled through the traction wheel to elevate the car, the structure is relatively complex, and the construction costs are high. Required installation positions are limited relatively greatly. During long-time running of the elevator, it is easy for the steel wire rope to slip, causing a hidden safety danger. Moreover, during elevator addition to the original multi-story building, because the hatchway of this elevator added outdoors is enclosed, affecting daylighting and ventilation of residents, opposition from particularly low-story residents is encountered. As a result, it is relatively difficult to add an outdoor elevator to a multi-story residential building.

### SUMMARY

To resolve the foregoing problems, an objective of the present invention is to provide an elevator that uses sprocket and chain transmission, an open hatchway structure, and a hidden counterbalancing design, and a method for controlling an elevator.

Technical solutions of the present invention are as follows: An elevator is provided, including a car and counterweights, where the elevator includes posts, a steel frame structure, and a power device, where the steel frame structure is fixed on the top of the elevator, and the power device is fixedly installed on the steel frame structure; and the counterweights are disposed in the posts;

further, the elevator is provided with a weight balancing device, the weight balancing device includes guide wheels, steel wire ropes, and the counterweights, and the counterweights are connected to the car through the steel wire ropes and the guide wheels, and used for balancing the car and a part of a weight of a load; and

further, the power device includes a motor speed reducer (or servo motor) equipped with a frequency converter and an encoder, and the frequency converter and the encoder are used for changing a rotational speed of a motor to control an ascending or descending speed of the elevator, where two output shafts are disposed on the motor speed reducer, and the two output shafts are the same in rotational speed and opposite in direction; and two sprockets and two chains connected to the two output shafts are disposed in the power device, and the two output shafts are driven by the motor to work simultaneously, so that the two output shafts simultaneously drive the two chains and the two sprockets to drive the car and the counterweights to move up or down.

Preferably, the elevator is provided with two posts and two counterweights, and the two counterweights are installed in the two posts respectively.

Preferably, the elevator is provided with four posts and four counterweights, and the four counterweights are installed in the four posts respectively.

Further, the elevator is provided with a hatchway, and a bottom layer of the hatchway of the elevator includes four working faces, where three working faces are each provided with a hatchway guardrail, used for preventing a walker from accidentally entering the hatchway, and one remaining working face is provided with an electric fence lift door, used by a person taking the elevator to get in or out.

Preferably, the top of the elevator is provided with a metal protective cover, and the metal protective cover is used for covering the power device, to prevent the power device from being exposed to the sun and rain.

Preferably, the bottom of the car is provided with a pressure sensor, an ultrasonic radar sensor, and a camera that are used for monitoring the elevator.

A method for controlling an elevator is provided, where the elevator includes: a car and counterweights; and posts, a steel frame structure, and a power device, where the steel frame structure is fixed on the top of the elevator, and the power device is fixedly installed on the steel frame structure; and the counterweights are disposed in the posts;

further, the elevator is provided with a weight balancing device, the weight balancing device includes guide wheels, steel wire ropes, and the counterweights, and the counterweights are connected to the car through the steel wire ropes and the guide wheels, and used for balancing the car and a part of a weight of a load; and

further, the power device includes a motor speed reducer (or servo motor) equipped with a frequency converter and an encoder, where two output shafts are disposed on the motor speed reducer, and two sprockets and two chains connected to the two output shafts are disposed in the power device; the two output shafts are set the same in rotational speed and opposite in direction; and the two output shafts are driven by a motor to work simultaneously, so that the two output shafts of the speed reducer simultaneously drive the two chains and the two sprockets to drive the car and the counterweights to move up or down.

Preferably, the counterweights are installed in the posts and hidden by disposing the posts (or circular posts or square posts).

Preferably, a walker is prevented from accidentally entering a hatchway by disposing the hatchway, hatchway guardrails, and an electric fence lift door.

Preferably, a metal protective cover is disposed on the top of the elevator, and the power device is installed in the metal protective cover, to protect the power device.

Beneficial effects of the present invention are as follows: 1. In each of the four-post structure and the two-post structure of the present invention, chains are pulled in a center position of the top of the car, and are subject to a more proper force.

2. In the present invention, the occupied space is small, the controlled motor speed reducer equipped with the encoder and the frequency converter drives more precisely, the controllability is stronger, and the present invention is generally applicable to an outdoor elevator, and may be used for adding an elevator to a multi-story residential building.

3. In the present invention, the elevator with the four-post hatchway structure has a maximum load of 500 kilograms and a person carrying capacity of 6 to 8 persons; and the elevator with the two-post hatchway structure has a maximum load of 200 kilograms and a person carrying capacity of 2 to 3 persons.

4. An average running speed of the elevator of the present invention is 0.20 to 0.40 meters/second.

5. An innovative hidden design is used for the counterweights of the present invention, the counterweights used for balancing the weight of the car are installed in the posts, the counterweights are invisible from the outside, and ventilation and daylighting around the elevator are not affected.

6. An open design is used for the hatchway of the present invention, where in addition to the safety guardrails and the electric fence door that are installed outside the hatchway at the bottom layer, only four posts can be seen from the outside, and the car is automatically elevated to the top when not used in a specified time, so that impact on both ventilation and daylighting of residents is greatly reduced.

7. In the technical solutions of the present invention, the four steel wire ropes are connected to the car and the counterweights through the guide wheel to balance the car and a part of the weight of the load, to increase running safety and stability of the elevator system, and avoid the phenomenon that the frequently used steel wire traction machine mechanism usually slips.

8. In addition to addition of a plurality of safety sensor devices such as a touch switch and a speed detecting sensor, the present invention also has various safety functions of the conventional elevator.

9. Compared with the existing technology, in the present invention, current opposition to addition of an outdoor elevator to a multi-story building mostly come from low-story residents worrying about daylighting and ventilation. In the present invention, after installation is completed, impact on ventilation and daylighting of residents is small, and particularly, impact on low-story residents is smaller (when the elevator is not used, the elevator may be elevated to the top). In this way, antagonism to addition of an elevator to a low-story dwelling is reduced, so that elevator addition can be smoothly permitted by low-story residents.

10. In the present invention, a sprocket and chain transmission manner is used, to avoid a slipping phenomenon during running.

11. In the two embodiments (four-post and two-post elevators) of the present invention, installation is quite convenient, and may be completed in about 15 days.

To sum up, the present invention has advantages such as being simple in structure, precise in control, stable in running, high in safety, small in occupied space, convenient in installation, low in construction costs, wide in use range, and strong in applicability.

### BRIEF DESCRIPTION OF THE DRAWINGS

FIG. 1 is a schematic diagram of an integral structure of a four-post elevator according to Embodiment 1 of the present invention;

FIG. 2 is a schematic structural diagram of a power device of the four-post elevator according to Embodiment 1 of the present invention;

FIG. 3 is a schematic diagram of an internal structure of a four-post elevator cut along a diagonal line according to Embodiment 1 of the present invention;

FIG. 4 is a schematic diagram of an integral structure of a two-post elevator according to Embodiment 2 of the present invention; and

FIG. 5 is a schematic diagram of a cross-sectional structure of a two-post elevator according to Embodiment 2 of the present invention.

In the figures: 1, metal protective cover; 2, post; 3, beam; 4, car; 5, hatchway guardrail; 6, electric fence retractable door (unidirectional or bidirectional); 7, power device; 8, chain; 9, sprocket; 10, counterweight; 11, guide wheel; 12, steel wire rope; 13, steel frame structure; 14, simple equipment room.

### DETAILED DESCRIPTION

The following describes the technical solutions of the present invention in detail with reference to accompanying drawings and embodiments.

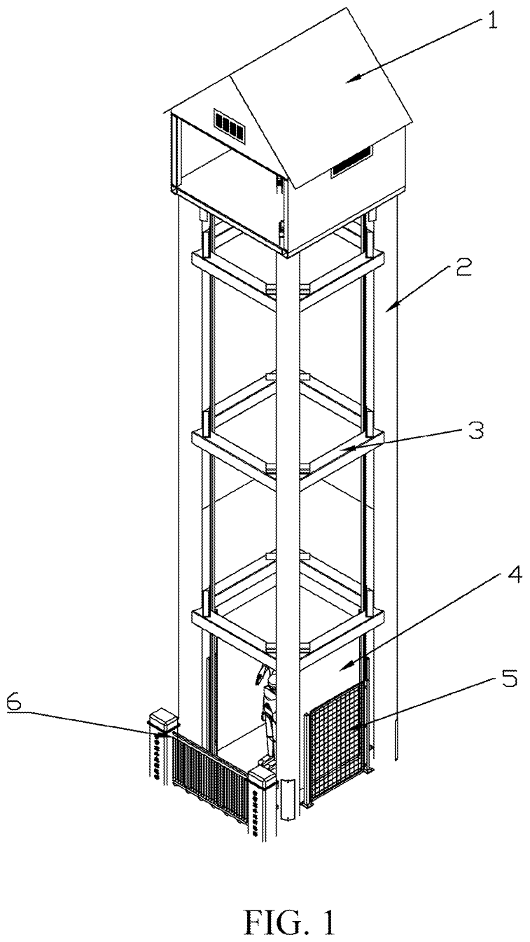

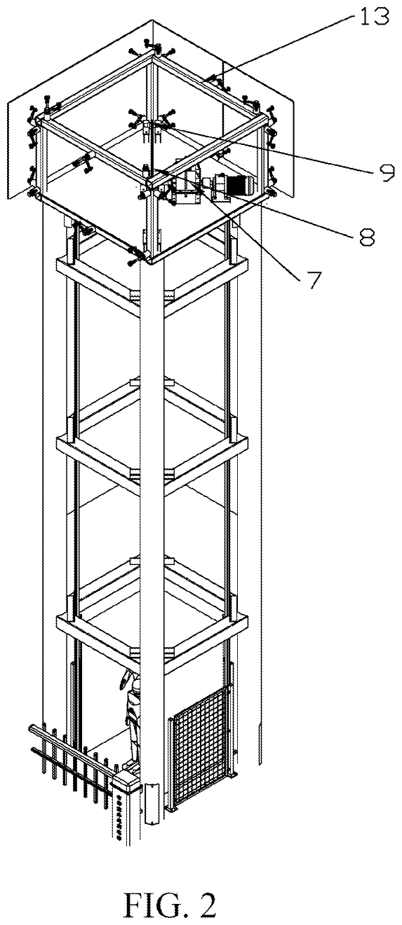

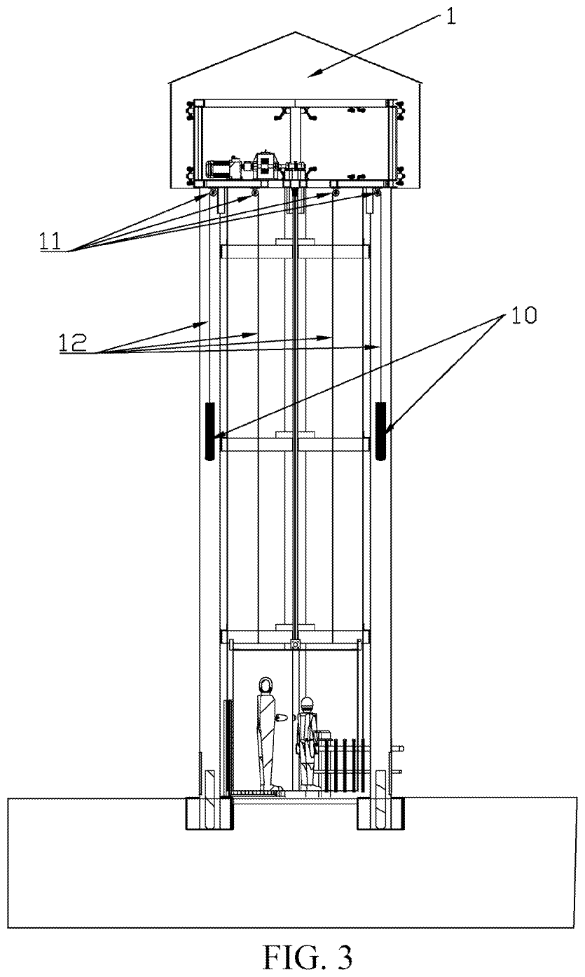

In Embodiment 1 shown in FIG. 1, FIG. 2, and FIG. 3, a four-post elevator includes a hatchway, beams (3), a car (4), counterweights (10), four posts (2), a steel frame structure (13), and a power device (7), where the steel frame structure is fixed on the top of the elevator, and the power device is fixedly installed on the steel frame structure; and the counterweights are disposed in the posts.

The top of the four-post elevator is provided with a metal protective cover (1), and the power device is installed in the metal protective cover, to prevent the power device from being exposed to rain. The power device includes a motor speed reducer (or servo motor) equipped with an encoder and a frequency converter, sprockets (9), a driving shaft, a coupling, and a mounted bearing, and a rotational speed of a motor may be changed through the frequency converter and the encoder to control an ascending or descending speed of the elevator. When the elevator works, the motor on the power device drives two output shafts on the dual-output-shaft speed reducer to work simultaneously. The two output shafts on the speed reducer are the same in rotational speed and opposite in direction. Chains (8) and the sprockets (9) are driven simultaneously through two sprockets installed on the two output shafts of the speed reducer to drive the car (4) and the counterweights (10) installed in the two posts (2) to move up or down. Moreover, the four counterweights 10 are connected to the car through steel wire ropes 12 and guide wheels 11, and may balance the car and a part of a weight of a load, thereby reducing power consumption of the motor. The four counterweights 10 are respectively installed in the four posts 2. To prevent a walker from accidentally entering the hatchway of the elevator, at a bottom layer of the hatchway, three faces are each provided with a hatchway guardrail (5), and one face is provided with an electric fence lift door (6), for a person taking the elevator to get in or out.

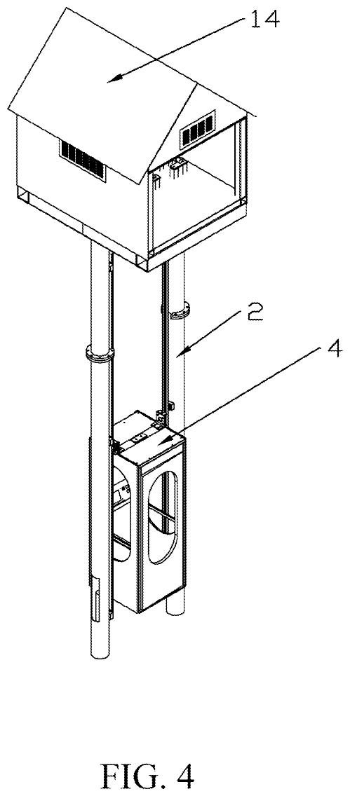

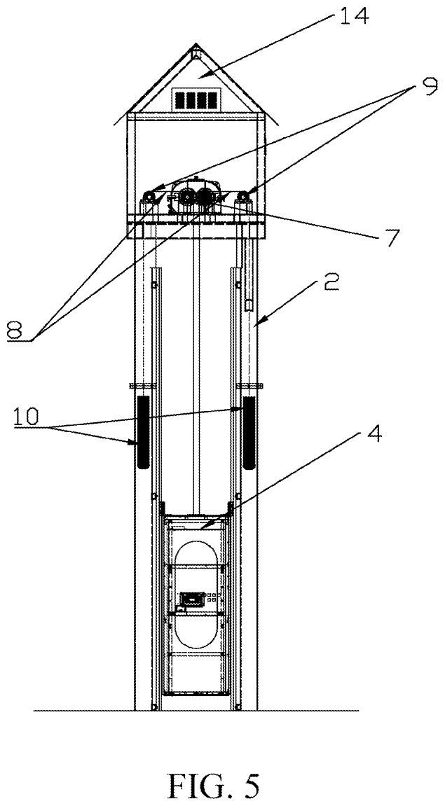

In Embodiment 2 shown in FIG. 4 and FIG. 5, a two-post elevator includes a top simple equipment room (14) with a sheet metal structure, a car (4), counterweights (10), two posts (2), and a power device (7). When the elevator works, a motor on the power device drives two output shafts on a dual-output-shaft speed reducer to work simultaneously.

The two output shafts on the speed reducer are the same in rotational speed and opposite in direction. Chains 8 and the sprockets 9 are driven simultaneously through two sprockets installed on the two output shafts of the speed reducer to drive the car 4 and the two counterweights 10 to move up or down. The two counterweights 10 are respectively installed in the two posts 2. The bottom of the car is provided with safety facilities such as a pressure sensor, an ultrasonic radar sensor, and a camera, to ensure that the elevator can stop in time when a person or an animal and a foreign matter abnormally enter the elevator at the bottom layer, to avoid damaging the person or animal, and the elevator.

A method for controlling an elevator is provided, where the elevator includes: a car and counterweights; and posts, a steel frame structure, and a power device, where the steel frame structure is fixed on the top of the elevator, and the power device is fixedly installed on the steel frame structure; and the counterweights are disposed in the posts;

further, the elevator is provided with a weight balancing device, the weight balancing device includes guide wheels, steel wire ropes, and the counterweights, and the counterweights are connected to the car through the steel wire ropes and the guide wheels, and used for balancing the car and a part of a weight of a load; and

further, the power device includes a motor speed reducer (or servo motor) equipped with a frequency converter and an encoder, where two output shafts are disposed on the motor speed reducer, and two sprockets and two chains connected to the two output shafts are disposed in the power device; the two output shafts are set the same in rotational speed and opposite in direction; and the two output shafts are driven by a motor to work simultaneously, so that the two output shafts of the speed reducer simultaneously drive the two chains and the two sprockets to drive the car and the counterweights to move up or down.

Preferably, the counterweights are installed in the posts and hidden by disposing the posts (or circular posts or square posts).

Preferably, a walker is prevented from accidentally entering a hatchway by disposing the hatchway, hatchway guardrails, and an electric fence lift door.

Preferably, a metal protective cover is disposed on the top of the elevator, and the power device is installed in the metal protective cover, to protect the power device.

The foregoing descriptions involve only some specific embodiments of the present invention, and each replacement or improvement made by any person skilled in the art based on the spirit of the present invention should fall within the protection scope of the present invention. Therefore, the protection scope of the present invention should be subject to the claims.

What is claimed is:

1. An elevator, comprising a car and counterweights, wherein the elevator comprises posts, a steel frame structure, and a power device, wherein the steel frame structure is fixed on the top of the elevator, and the power device is fixedly installed on the steel frame structure; and the counterweights are disposed in the posts;
further, the elevator is provided with a weight balancing device, the weight balancing device comprises guide wheels, steel wire ropes, and the counterweights, and the counterweights are connected to the car through the steel wire ropes and the guide wheels, and used for balancing the car and a part of a weight of a load; and
the power device comprises a motor speed reducer equipped with a frequency converter and an encoder, and the frequency converter and the encoder are used for changing a rotational speed of a motor to control an ascending or descending speed of the elevator, wherein two output shafts are disposed on the motor speed reducer, and the two output shafts are the same in rotational speed and opposite in direction; and two sprockets and two chains connected to the two output shafts are disposed in the power device, and the two output shafts are driven by the motor to work simultaneously, so that the two output shafts simultaneously drive the two chains and the two sprockets to drive the car and the counterweights to move up or down.

2. The elevator according to claim 1, wherein the elevator is provided with two posts and two counterweights, and the two counterweights are installed in the two posts respectively.

3. The elevator according to claim 1, wherein the elevator is provided with four posts and four counterweights, and the four counterweights are installed in the four posts respectively.

4. The elevator according to claim 3, wherein the elevator is provided with a hatchway, and a bottom layer of the hatchway of the elevator comprises four working faces, wherein three working faces are each provided with a hatchway guardrail, used for preventing a walker from accidentally entering the hatchway, and one remaining working face is provided with an electric fence lift door, used by a person taking the elevator to get in or out.

5. The elevator according to claim 1, wherein the top of the elevator is provided with a metal protective cover, and the metal protective cover is used for covering the power device, to prevent the power device from being exposed to the sun and rain.

6. The elevator according to claim 1, wherein the bottom of the car is provided with a pressure sensor, an ultrasonic radar sensor, and a camera that are used for monitoring the elevator.

7. A method for controlling an elevator, wherein the elevator comprises: a car and counterweights; and posts, a steel frame structure, and a power device, wherein the steel frame structure is fixed on the top of the elevator, and the power device is fixedly installed on the steel frame structure; and the counterweights are disposed in the posts;
further, the elevator is provided with a weight balancing device, the weight balancing device comprises guide wheels, steel wire ropes, and the counterweights, and the counterweights are connected to the car through the steel wire ropes and the guide wheels, and used for balancing the car and a part of a weight of a load; and
further, the power device comprises a motor speed reducer equipped with a frequency converter and an encoder, wherein two output shafts are disposed on the motor speed reducer, and two sprockets and two chains connected to the two output shafts are disposed in the power device; the two output shafts are set the same in rotational speed and opposite in direction; and the two output shafts are driven by a motor to work simultaneously, so that the two output shafts of the speed reducer simultaneously drive the two chains and the two sprockets to drive the car and the counterweights to move up or down.

8. The method for controlling an elevator according to claim 7, wherein the counterweights are installed in the posts and hidden by disposing the posts.

9. The method for controlling an elevator according to claim 7, wherein a walker is prevented from accidentally entering a hatchway by disposing the hatchway, hatchway guardrails, and an electric fence lift door.

10. The method for controlling an elevator according to claim 7, wherein a metal protective cover is disposed on the top of the elevator, and the power device is installed in the metal protective cover, to protect the power device.
